(19) United States
(12) Patent Application Publication
(10) Pub. No.: US 2016/0035486 A1
(43) Pub. Date: Feb. 4, 2016

(54) SECONDARY-SIDE COIL ASSEMBLY FOR INDUCTIVE ENERGY TRANSFER USING QUADRUPOLES

(71) Applicant: PAUL VAHLE GMBH & CO. KG, Kamen (DE)

(72) Inventors: Faical TURKI, Bergkamen (DE); Jürgen MEINS, Braunschweig (DE)

(73) Assignee: PAUL VAHLE GMBH & CO. KG, Kamen (DE)

(21) Appl. No.: 14/775,210

(22) PCT Filed: Dec. 6, 2013
(86) PCT No.: PCT/EP2013/075841

§ 371 Date: Sep. 11, 2015

(30) Foreign Application Priority Data
Mar. 12, 2013 (DE) 10 2013 004 181.3

(51) Int. Cl. H01F 38/14; H02J 5/00

(52) U.S. Cl. CPC H01F 38/14; H02J 5/005

(57) ABSTRACT

The invention relates to a secondary-side coil arrangement for an inductive energy transmission system for transmitting energy between a primary-side and a secondary-side coil arrangement (A₁, A₂), characterised in that the secondary-side coil arrangement (A₁) has coils (SS₁, SS₂, SS₃, SS₄) which form four coil regions (BE_{S1}, BE_{S2}, BE_{S3}, BE_{S4}) of the coil arrangement (A₁) which are arranged beside each other in a plane, wherein each coil (SS₁, SS₂, SS₃, SS₄) forms an oscillating circuit (RES_{S}) together with at least one capacitor (C_{S1-4}).

The present invention relates to a secondary-side coil arrangement for an inductive energy transmission system for transmitting energy between a primary-side and a secondary-side coil arrangement.

Secondary-side coil arrangements for inductive energy transmission systems are known in many forms. There are used, for example, simple circular planar coils or two planar rectangular coils which are arranged beside each other in a plane for energy transmission at the secondary side.

An object of the present invention is to provide a secondary-side coil arrangement which can cooperate with different primary-side coil arrangements with a high degree of efficiency.

This object is achieved according to the invention with a secondary-side coil arrangement which has coils which form four coil regions which are arranged beside each other in a plane, wherein each coil forms an oscillating circuit together with at least one capacitor. As a result of the advantageous provision of four coil regions which are arranged beside each other, it is possible for the secondary-side coil arrangement to be able to cooperate with differently constructed primary coil arrangements. The secondary-side coil arrangement according to the invention can thus cooperate with a primary coil arrangement which has only one, two or four coil regions.

In the individual coils which form the coil regions, or the windings thereof, depending on the phase relations of the primary-side associated coil regions, in-phase currents or also currents with different phase relations can be induced. These currents can be converted by means of rectifiers to form a smoothed output voltage.

The four coil regions are located beside each other in the four quadrants of a coordinate system, which is defined by the coils themselves.

The secondary-side coil arrangement for an inductive energy transmission system may have a rectangular, in particular square, round, in particular circular, or elliptical outer contour. Other shapes, in particular shapes with more than four corners, are also possible.

The secondary-side coil arrangement according to the invention may either be formed by planar coils on a flat ferrite arrangement or be a solenoid arrangement.

When planar windings are used on a ferrite arrangement, in particular a ferrite plate, the coil regions are either contained or formed by four separate circular windings or they are formed by a plurality of planar coils which partially overlap, wherein each coil region is advantageously contained or surrounded by regions of two coils. The complete containment or surrounding of a coil region is carried out in this instance by both coils which form the respective coil region together.

In this instance, each coil advantageously covers two adjacent coil regions or two coil regions which are arranged diagonally with respect to each other.

Advantageously, the four planar coils are constructed in a rectangular manner, wherein two coils form a coil pair in each case and the coil pairs are rotated through 90° with respect to each other and are arranged one above the other. The coils which form the coil pairs may advantageously be formed in each case by a single winding, in particular having a centre tap. This simplifies the structure of the coil arrangement.

In the secondary-side coil arrangement according to the invention, the coils of a coil pair are advantageously connected in series, wherein a centre tap impedance is electrically connected with the first pole thereof to the connection location of the two coils which are connected in series and with the other pole thereof is electrically connected to the centre location/centre tap of a voltage divider, the plus or minus pole of the rectifier. The provision according to the invention of an additional impedance, in the event of an offset with respect to the optimum horizontal orientation, results in an increase of the inductivity in the series oscillating circuit of the primary-side and/or secondary-side coils which are connected in series, whereby an adaptation of the resonance frequency of the oscillating circuit to the system frequency is carried out.

If the secondary-side coil arrangement is formed by a solenoid arrangement, the windings which form the coils are in abutment with the flat sides and the narrow end sides of a ferrite plate. The windings which form the coils may in this instance each have a centre tap so that the windings form coils which are connected in series. The winding members of the intersecting windings divide the ferrite plate into regions which form the coil regions.

The invention is explained in greater detail below with reference to drawings, in which:

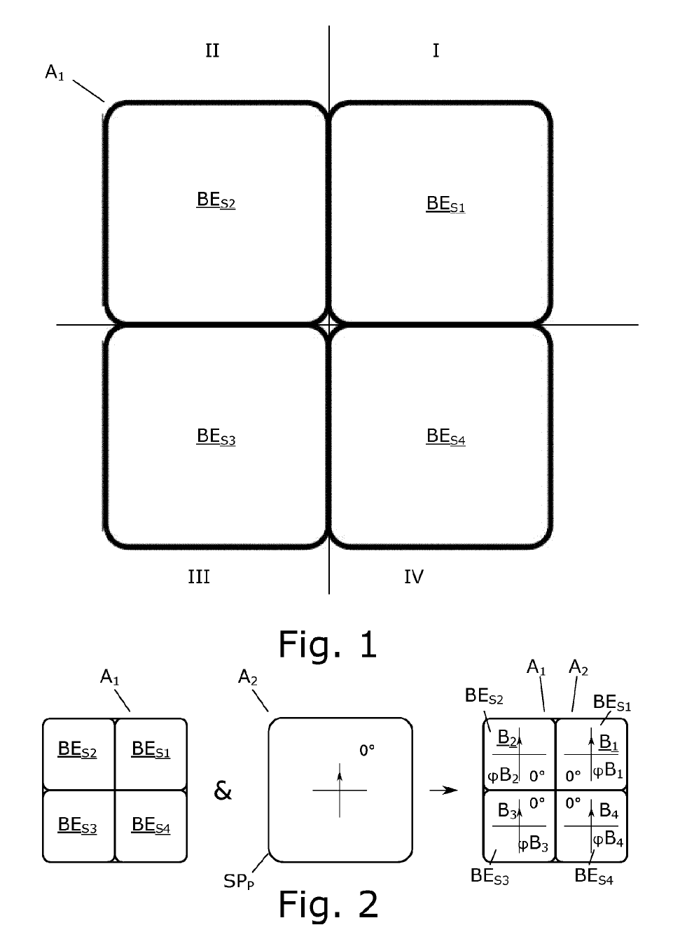

FIG. 1: shows a coil arrangement according to the invention with four coil regions which are located in a plane;

FIG. 2: shows a secondary coil arrangement with four coil regions cooperating with a primary circular coil arrangement;

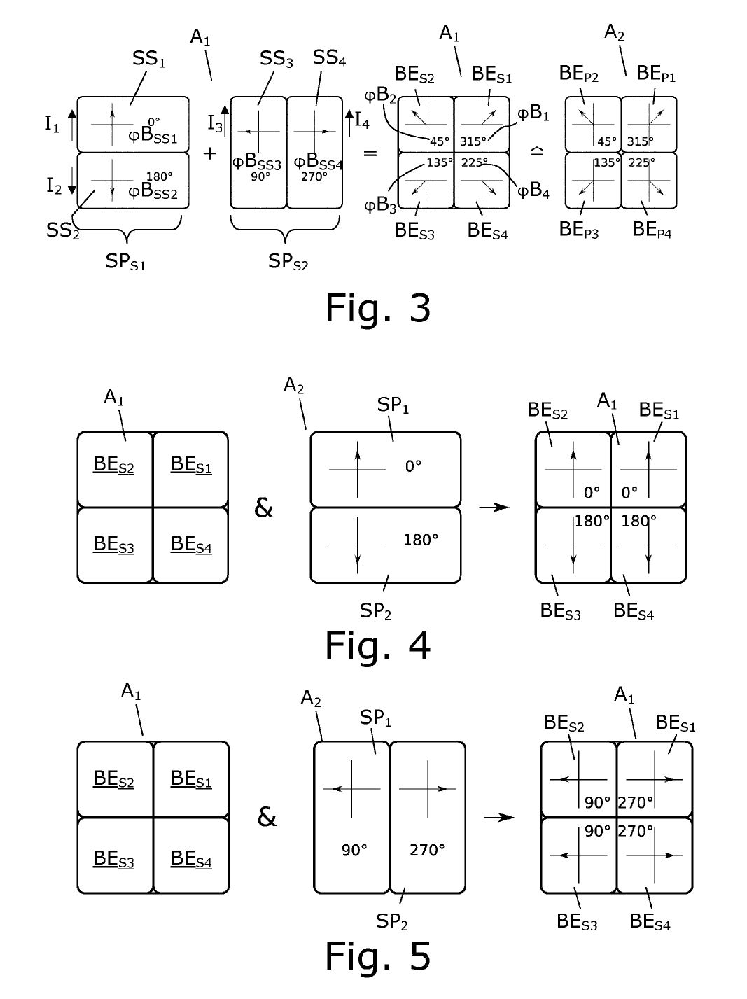

FIG. 3: shows a secondary coil arrangement comprising four planar rectangular coils cooperating with a primary coil arrangement having four coil regions with magnetic fluxes of different phase relations;

FIGS. 4 and 5: show a secondary coil arrangement with four coil regions cooperating with a primary coil arrangement comprising two rectangular coils;

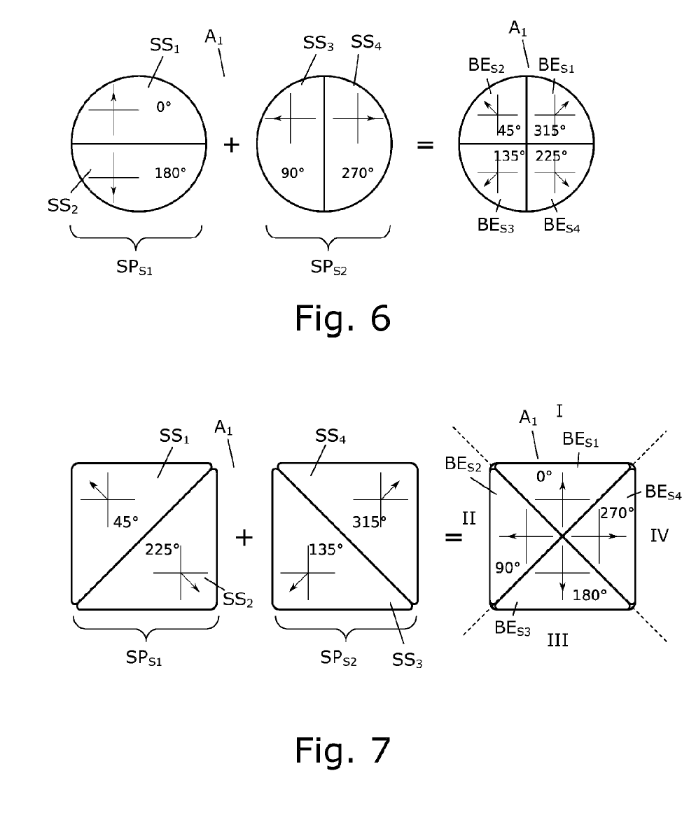

FIG. 6: shows a secondary coil arrangement comprising four semi-circular and overlapping coils;

FIG. 7: shows a secondary coil arrangement comprising four triangular and overlapping coils;

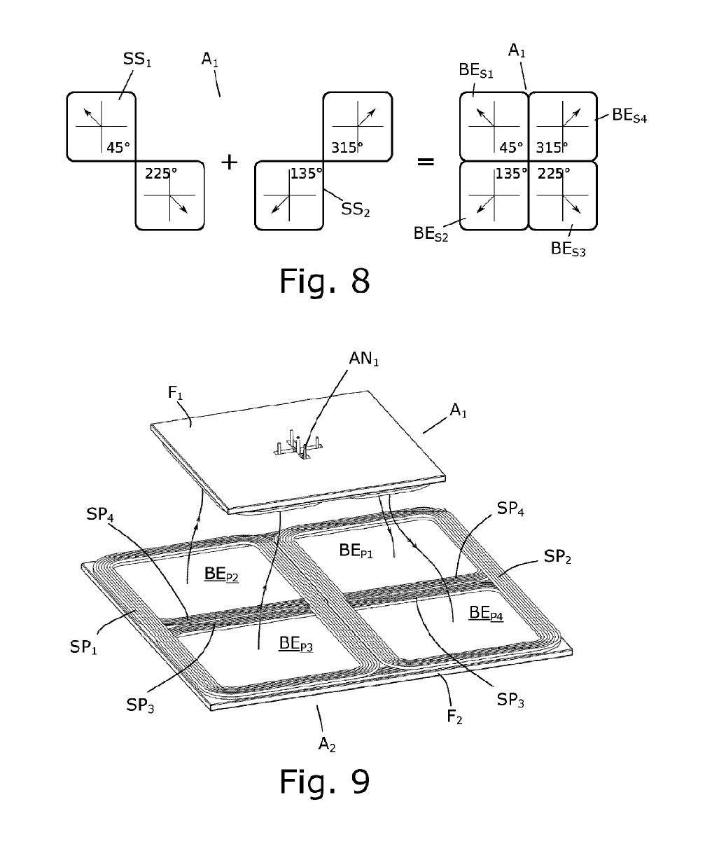

FIG. 8: shows a special form of a secondary coil arrangement comprising coils which form two figure eights and which are arranged orthogonally with respect to each other and form four coil regions;

FIG. 9: shows an inductive energy transmission device with a primary-side and a secondary-side coil arrangement;

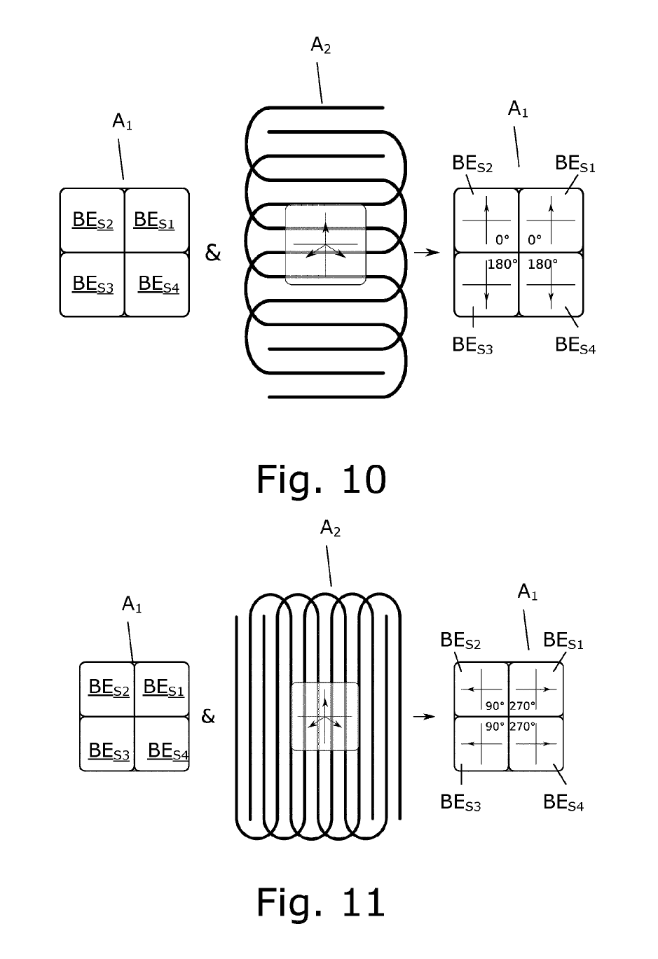

FIGS. 10 and 11: show a secondary-side coil arrangement cooperating with 3-phase primary conductors which are laid in strips;

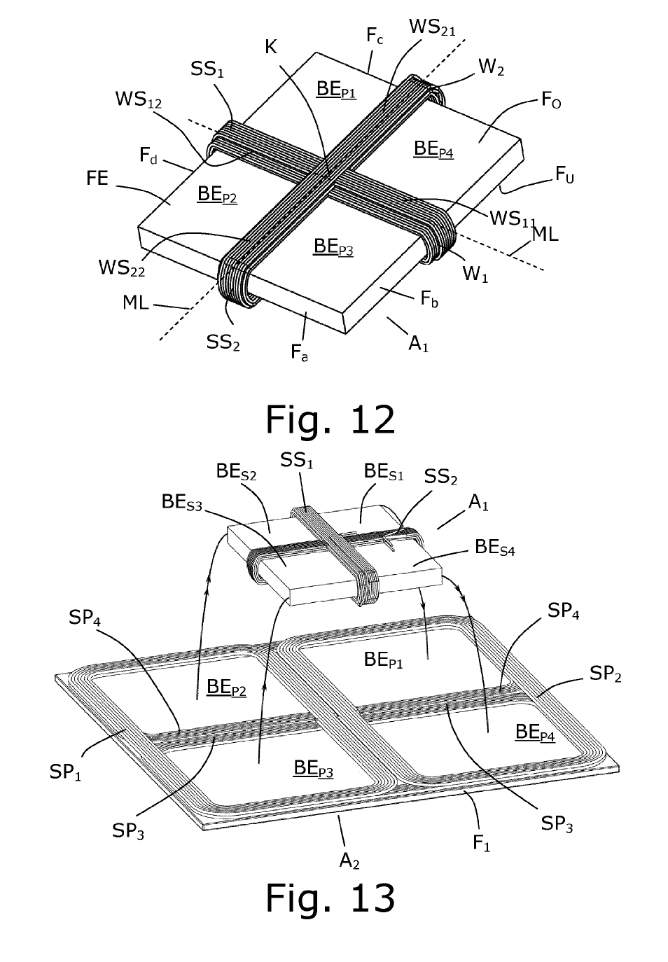

FIG. 12: shows a possible embodiment of the secondary coil arrangement as a solenoid;

FIG. 13: shows a primary coil arrangement according to FIG. 9 with a secondary solenoid coil arrangement;

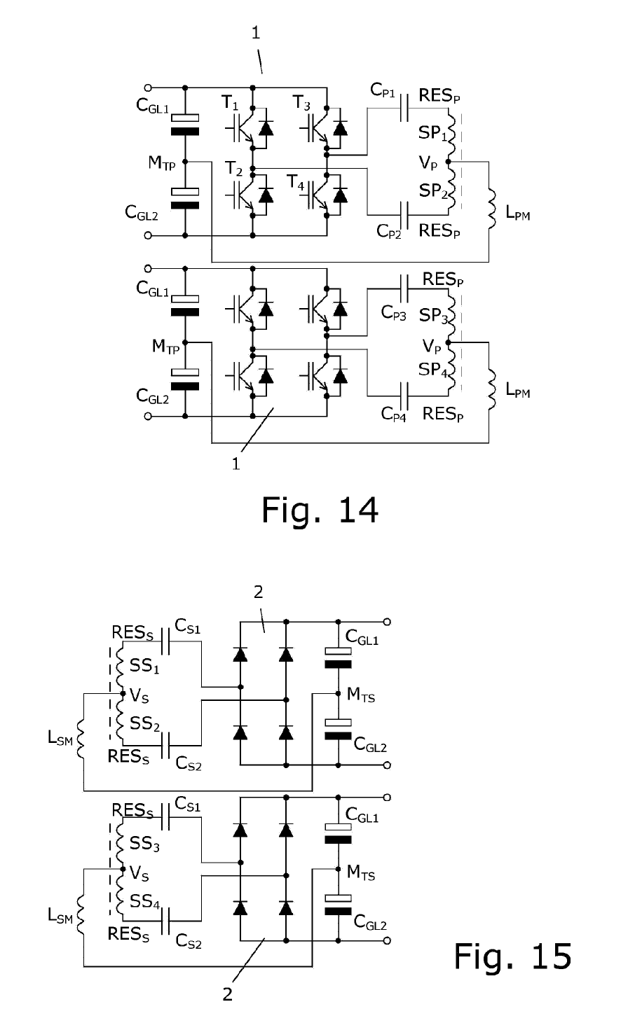

FIG. 14: shows a circuit for the primary side of an inductive energy transmission system;

FIG. 15: shows a circuit for the secondary side of an inductive energy transmission system.

FIG. 1 shows a coil arrangement A₁ according to the invention having four coil regions BE_{S1}, BE_{S2}, BE_{S3} and BE_{S4}which are arranged in a plane. For better understanding of the invention, the coil regions BE_{S1}, BE_{S2}, BE_{S3} and BE_{S4}are arranged in the quadrants I to IV.

Of course, it is also possible for the individual coil regions BE_{S1}, BE_{S2}, BE_{S3} and BE_{S4}to have different shapes and sizes with respect to each other. The coil regions BE_{S1}, BE_{S2}, BE_{S3} and BE_{S4}are defined by coils which are not illustrated in FIG. 1 since the coil forms and number of coils may be constructed differently.

Depending on the type of the primary-side coil arrangement A₂ used, the phase relation of the currents is adjusted in the individual coils which surround the coil regions BE_{S1}, BE_{S2}, BE_{S3} and BE_{S4}.

FIG. 2 shows a secondary coil arrangement A₁ according to the invention having four coil regions BE_{S1}, BE_{S2}, BE_{S3} and BE_{S4}in cooperation with a primary coil arrangement A₂ with a circular coil SP_{P}. The coil arrangements A₁ and A₂ preferably have identical outer contours. However, it is possible for the shape and size of the coil arrangements A₁ and A₂ to differ from each other. During the energy transmission from the primary-side coil arrangement A₂ to the secondary-side coil arrangement A₁, depending on the horizontal position of the coil arrangements A₁, A₂ with respect to each other, currents with different phase relations are adjusted in the individual coils SS₁₋₄.

FIG. 3 shows a secondary coil arrangement A₁ comprising four rectangular coils SS₁ to SS₄. The coils SS₁ and SS₂ form a first coil pair SP_{S1} and the coils SS₃ and SS₄ form a second coil pair SP_{S2}. The phase relations φI₁ of the resulting currents I₁₋₄ in the coils SS₁₋₄ are decisively dependent on the structure of the primary-side coil arrangement A₂. FIG. 3 illustrates on the right a primary coil arrangement A₂ having four coil regions BE_{P1-4}, wherein the magnetic flux densities B₁₋₄ in the individual coil regions BE_{P1-4} are 45°, 135°, 225° and 315°. Those magnetic flux densities also flow through the coil regions BE_{S1-4} of the secondary coil arrangement A₁, whereby currents I₁₋₄ results in the coils SS₁₋₄ with corresponding phase relations. The phase relations φI₁₋₄ of the currents I₁₋₄ vary in accordance with the horizontal orientation of the coil arrangements A₁ and A₂ relative to each other.

FIGS. 4 and 5 show a secondary coil arrangement A₁ which can be constructed identically to the coil arrangement A₁ illustrated in FIG. 3 in conjunction with a primary coil arrangement A₂ comprising two rectangular coils SP₁ and SP₂ which are operated in differential mode. The coil regions BE_{S1-4} are constructed in such a manner that two coil regions BE_{S1}, BE_{S2}, BE_{S3}, BE_{S4} arranged beside each other cooperate with a primary-side coil SP₁ and SP₂, respectively, or are arranged thereabove during the energy transmission. The magnetic fluxes Bᵢ in the primary coils SP₁ and SP₂ pass through the associated coil regions BE_{S1}, BE_{S2}, BE_{S3}, BE_{S4} and produce the currents I₁₋₄in the secondary-side coils SS₁₋₄with corresponding phase relations.

In the relative orientation of the secondary coil arrangement A₁ in relation to the primary-side coil arrangement A₂ as shown in FIG. 4, the coil regions BE_{S1} and BE_{S4} correspond to the coil SP₁ and the coil regions BE_{S2} and BE_{S3} correspond to the coil SP₂. The phase relations of the magnetic flux densities B of the coil regions BE_{S1} and BE_{S4} and the coil regions BE_{S2} and BE_{S3} are shifted relative to each about 180°, whereby corresponding phase relations φI₁₋₄of the coil currents I₁₋₄ result in the coils SS₁₋₄relative to each other.

In the relative orientation of the secondary coil arrangement A₁ in relation to the primary-side coil arrangement A₂ as shown in FIG. 5, the coil regions BE_{S1} and BE_{S4} correspond to the coil SP₁ and the coil regions BE_{S2} and BE_{S3} correspond to the coil SP₂.

FIG. 6 shows a secondary coil arrangement A₁ comprising four coils SS₁₋₄overlapping each other. They form in a state arranged one above the other the coil regions BE_{S1-4}. The only difference in relation to the construction in comparison with the embodiment shown in FIG. 3 involves the coils SS₁₋₄not being constructed to be rectangular but instead semi-circular.

FIG. 7 shows a secondary coil arrangement A₁ comprising four coils SS₁₋₄ overlapping each other. They form in a state arranged one above the other the coil regions BE_{S1-4}. The only difference in relation to the construction in comparison with the embodiment shown in FIG. 3 involves the coils SS₁₋₄ not being constructed to be rectangular but instead triangular. The coordinate system with the quadrants I to IV thereof is pivoted through 45° in contrast to the above-described embodiments, as illustrated with broken lines on the right in FIG. 7.

FIG. 8 shows a special form of a secondary coil arrangement A₁ comprising two figure-8-like coils SS₁ and SS₂ which each form two rectangular coil regions BE_{S1}, BE_{S2} and BE_{S3}, BE_{S4} which are arranged orthogonally relative to each other and consequently form four adjacent coil regions.

FIG. 9 shows an inductive energy transmission device with a primary-side and a secondary-side coil arrangement A₁, A₂. The planar windings form the coils of the coil arrangements A₁, A₂ together with the ferrite plates F₁, F₂. The primary-side coils SP₁₋₄ are constructed to be rectangular and are arranged relative to each other in accordance with the embodiment described and illustrated in FIG. 3 so that they form the coil regions BE_{P1}, BE_{P2}, BE_{P3} and BE_{P4} together. The coil connections AN₁ of the secondary-side coil arrangement A₁ extend upwards through a recess at the centre of the ferrite plate F₁.

FIGS. 10 and 11 illustrate that the secondary-side coil arrangements A₁ according to the invention can also be used with multi-phase primary arrangements arranged in strips. The individual coil regions BE_{S1-4} are penetrated in this case by the magnetic fluxes which are illustrated on the right and which have the phase positions 0° and 180°.

FIG. 12 shows a possible embodiment of the secondary coil arrangement A₁ as a solenoid. The coil arrangement A₁ has a ferrite plate FE which has narrow end sides F_{a-d} and a flat upper side F_{O} and a flat lower side F_{U}. Windings W₁, W₂ which are arranged orthogonally relative to each other and which intersect at the upper side F_{O} at the centre K of the ferrite plate FE are wound around the ferrite plate FE. The windings W₁, W₂ form the coils SS_{1,2}. The windings W₁ and W₂ define with the arms WS₁₁, WS₁₂, WS₂₁, WS₂₂ thereof the coil regions BE_{S1}, BE_{S2}, BE_{S3} and BE_{S4}. Corresponding currents are produced in the coils SS_{1,2} as a result of the magnetic flux densities which are introduced into the coil regions BE_{S1}, BE_{S2}, BE_{S3} and BE_{S4} and which are by the primary-side arrangement, as described and illustrated in FIG. 13.

FIG. 13 shows a primary coil arrangement of the secondary solenoid coil arrangement A₁ illustrated in FIG. 12. The primary coil arrangement A₂ is constructed in accordance with the coil arrangement according to FIG. 3.

FIG. 14 shows the structure of a primary-side circuit which is supplied by two controlled bridge inverters 1. The primary-side coils SP₁ and SP₂ are connected in series to oscillating circuit capacitors C_{P1} and C_{P2} and form the resonance circuits RES_{P} together therewith. The coil currents I₁ and I₂ are adjusted by means of the switches T1-4. Similarly, the coils SP₃ and SP₄ are connected in series to oscillating circuit capacitors C_{P3} and C_{P4} and form additional resonance circuits RES_{P} together therewith. The coil currents I₃ and I₄ are adjusted by means of the switches T1-4.

A middle impedance L_{PM} is connected by means of one pole thereof to the connection location V_{P} and by means of the other pole thereof to the centre tap M_{TP} of the capacitive voltage divider C_{GL1}, C_{GL2} and serves to adapt the resonance frequencies in the event of a change of the total impedance of the primary-side oscillating circuits RES_{P}. The total impedance can be produced in particular by means of a horizontal offset between the primary-side and secondary-side coil arrangements A₁, A₂.

FIG. 15 shows a circuit structure for a secondary-side arrangement A₁. The coils SS₁ and SS₂ are connected in series to oscillating circuit capacitors C_{S1} and C_{S2} and form the resonance circuits RES_{S} together therewith. The two oscillating circuits are connected to each other in series, wherein the series connection of the oscillating circuits is connected to the alternating-current voltage connection of the first bridge rectifier 2 connected downstream. The output-side smoothing capacitors C_{GL1}, C_{GL2} form a capacitive voltage divider. Similarly, the coils SS₃ and SS₄ are connected in series to oscillating circuit capacitors C_{S3} and C_{S4} and form additional oscillating circuits RES_{S} together therewith. The two oscillating circuits RES_{S} are also connected to each other in series, wherein the series connection of the oscillating circuits is connected to the alternating-current voltage connection of the second bridge rectifier 2 connected downstream. The output-side smoothing capacitors C_{GL1}, C_{GL2} also form a capacitive voltage divider. By means of the additional impedances L_{SM}, there is brought about an automatic adjustment of the resonance frequencies of the oscillating circuits RESₛ to the system frequency if a change of the total impedance of the secondary-side oscillating circuits is produced as a result of a horizontal offset of the coil arrangements A₁, A₂ out of the optimum position because the phase relations of the currents change relative to each other. In this instance, the additional impedances are connected by means of the first pole thereof to the connection location of the coils SS₁ and SS₂ or SS₃ and SS₄ and are connected by means of the other pole thereof to the centre tap of the capacitive voltage divider C_{GL1}, C_{GL2}.

1. A secondary-side coil arrangement for an inductive energy transmission system for transmitting energy between primary-side and a secondary-side coil arrangements the secondary-side coil arrangement comprising:
coils that form four coil regions of the coil arrangement, which are arranged beside each other in a plane, wherein each coil forms an oscillating circuit together with at least one capacitor.

2. The secondary-side coil arrangement for an inductive energy transmission system according to claim 1, wherein a respective one of the coils partially overlaps with at least two other coils and forms therewith two coil regions arranged spatially beside each other.

3. The secondary-side coil arrangement for an inductive energy transmission system according to claim 1, wherein each of the four coil regions is arranged in a quadrant.

4. The secondary-side coil arrangement for an inductive energy transmission system according to claim 1, wherein each coil covers only one or two coil regions.

5. The secondary-side coil arrangement for an inductive energy transmission system according to claim 1, wherein each coil covers two adjacent coil regions or two coil regions that are arranged diagonally with respect to each other.

6. The secondary-side coil arrangement for an inductive energy transmission system according to claim 1, further comprising at least one rectifier configured to rectify currents that are adjusted in the coils, wherein.

7. The secondary-side coil arrangement for an inductive energy transmission system according to claim 1, wherein the coils comprise four coils, and wherein the four coils are constructed in a rectangular manner, wherein at least two sets of two of the four coils form respective coil pairs, wherein the coil pairs are rotated through 90° with respect to each other and are arranged one above the other.

8. The secondary-side coil arrangement for an inductive energy transmission system according to any one of the preceding claims, characterised in that the respective primary- and secondary-side coil arrangements have a rectangular, round, or elliptical outer contour.

9. The secondary-side coil arrangement for an inductive energy transmission system according to claim 1, wherein the coils comprise four coils, and wherein the secondary-side coil arrangement, in addition to the four coils, further comprises at least one additional coil arranged so as to overlap with at least one of the four coil regions.

10. The secondary-side coil arrangement for an inductive energy transmission system according to claim 1, wherein respective pairs of the coils form coil pairs, and wherein the coils of a respective coil pair are connected in series, wherein a centre tap impedance is electrically connected with a first pole thereof to a connection location of a coil pair and with another pole thereof electrically connected to a centre location/centre tap of a voltage divider.

11. The secondary-side coil arrangement according to claim 1, wherein the coils are formed by planar windings.

12. The secondary-side coil arrangement according to claim 1, wherein respective pairs of the coils form coil pairs, and wherein the coils that form a respective coil pair are formed by a single winding with a centre tap.

13. The secondary-side coil arrangement for an inductive energy transmission system according to claim 1, wherein the coils are wound around a ferrite plate, wherein the coils are arranged at least on a flat side of the ferrite plate orthogonally with respect to each other or intersect at least in a center of the flat side of the ferrite plate, or both are arranged orthogonally with respect to each other on the flat side of the ferrite plate and intersect in the center of the flat side of the ferrite plate.

14. The secondary-side coil arrangement according to claim 13, wherein the secondary-side coil arrangement is a solenoid arrangement, wherein the coils are formed by windings, which are in abutment with flat sides and narrow end sides of the ferrite plate.

15. The secondary-side coil arrangement according to claim 13, wherein the windings are connected to two rectifiers.

16. The secondary-side coil arrangement according to claim 13, wherein winding arms of the windings together form an intersection location that divides the ferrite plate into regions that form the coil regions.
